(19) United States
(12) Patent Application Publication
(10) Pub. No.: US 2011/0216526 A1
(43) Pub. Date: Sep. 8, 2011

(54) ILLUMINABLE SHOWER HEAD

(75) Inventor: Renzhong Li, Xiamen (CN)

(73) Assignee: Xiamen Solex High-Tech Industries Co., Ltd., Fujian (CN)

(21) Appl. No.: 13/125,711

(22) PCT Filed: Nov. 27, 2008
(86) PCT No.: PCT/CN09/75170

§ 371 Date: Apr. 22, 2011

(30) Foreign Application Priority Data
Jan. 14, 2009 (CN) 200920136386.3

(51) Int. Cl. F21V 33/00

(52) U.S. Cl. 362/96

(57) ABSTRACT

Illuminable shower head, comprising a main body, a hydroelectric device arranged in the main body, a circuit board, an illuminant and a water outlet device arranged in front of the main body; the hydroelectric device is electrically connected with the circuit board and the illuminant; wherein said water outlet device is made of transparent material, said illuminant comprises a backlight and a plurality of LED lights, said backlight is disposed upon said water outlet device, said LED lights are disposed on the side surface of the periphery of the backlight and illuminate toward the backlight. The light emitted from the LED lights 51 can be conducted and unified by the backlight 52 and then illuminates the whole water output panel of the shower head, so the whole water output panel of the shower head will be luminous; moreover, the luminous water output panel will have the function of illumination.

### FIELD OF THE INVENTION

The present invention relates to a shower head applied for bath, especially to an illuminable shower head.

### BACKGROUND OF THE INVENTION

Along with the improvement of the living standards and the development of the technology, the consumer are paying more attention to the diversified and novel functions of household appliances when they decide to buy a certain household appliance.

Therefore, the existing shower head not only has various water output functions, but also has light-emitting function and display function; generally, the light-emitting function is realized by disposing pluralities of LED lights on the periphery of the water output face cover of the shower head, and disposing a hydroelectric device in the main body of shower head or equipping an external power to supply power for the LED lights, thus the shower head can emit light. However, in the conventional technique, only part of the shower head or only certain points of the shower head can emit light, the whole shower head can not be luminous.

### SUMMARY OF THE INVENTION

The objective of the present invention is to provide an illuminable shower head, whose water output panel can be luminous, it not only beautify the appearance of the shower head and amuse the operation, but also realize the function of illumination.

In order to realize the objective of the present invention, the technical solution of the present invention is: an illuminable shower head, comprising a main body, a hydroelectric device arranged in the main body, a circuit board, an illuminant and a water outlet device arranged in front of the main body; the hydroelectric device is electrically connected with the circuit board and the illuminant; wherein said water outlet device is made of transparent material, said illuminant comprises a backlight and a plurality of LED lights, said backlight is disposed upon said water outlet device, said LED lights are disposed on the side surface of the periphery of the backlight and illuminate toward the backlight.

Said hydroelectric device comprises an impeller and a generator driven by said impeller.

Said impeller is vertically disposed below water inlet of the main body.

The hydroelectric device is disposed upon the main body, the water outlet device is disposed below the hydroelectric device, a space is formed between the peripheries of the water outlet device and the main body, the LED lights in the illuminant are disposed in said space, further the circuit board is disposed in a space upon the main body.

Said water outlet device comprises a transparent face cover with pluralities of water nozzles and a transparent upper cover for said face cover, a water inlet is disposed on the middle of the upper cover and hermetically connected with the hydroelectric device after passing through the backlight, the face cover buckles and seals the lower end of the main body and a water inflow chamber is formed between said face cover and the upper cover.

A shading ornamental ring is disposed on the periphery of the face cover and corresponds to the LED lights.

The size of the backlight matches the size of the water outlet panel in the water outlet device, further the backlight is disposed in a space upon the water outlet device.

A through hole is disposed on the middle of the backlight communicated with the water inlet of the water outlet device.

After applied the above solution, since the water outlet device of the shower head is made of transparent material, and the backlight of the illuminant is disposed upon the water outlet device, so the light from the LED lights is conducted and unified by the backlight and then illuminate the whole water output panel of the shower head, thus the whole water output panel of the shower head can be luminous; it further realize the function of illumination.

### BRIEF DESCRIPTION OF THE DRAWINGS

FIG. 1 is the sectional structural view of the present invention;

FIG. 2 is another direction of the sectional structural view of the present invention.

### DETAILED DESCRIPTION OF THE EMBODIMENTS

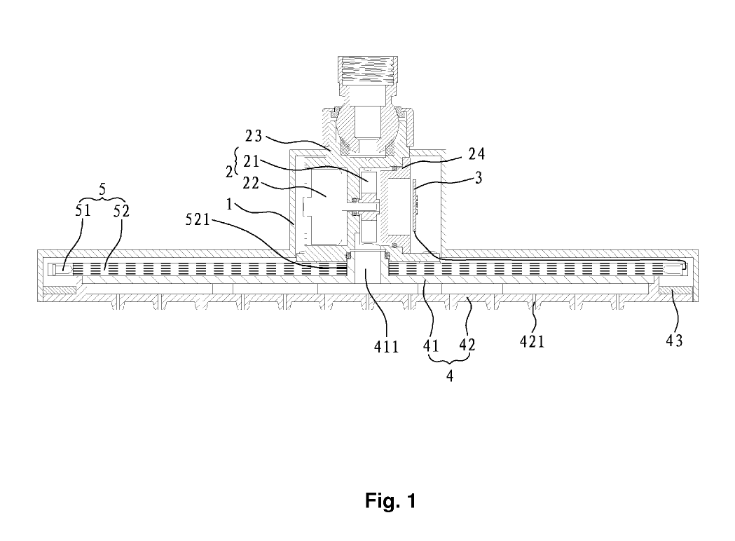

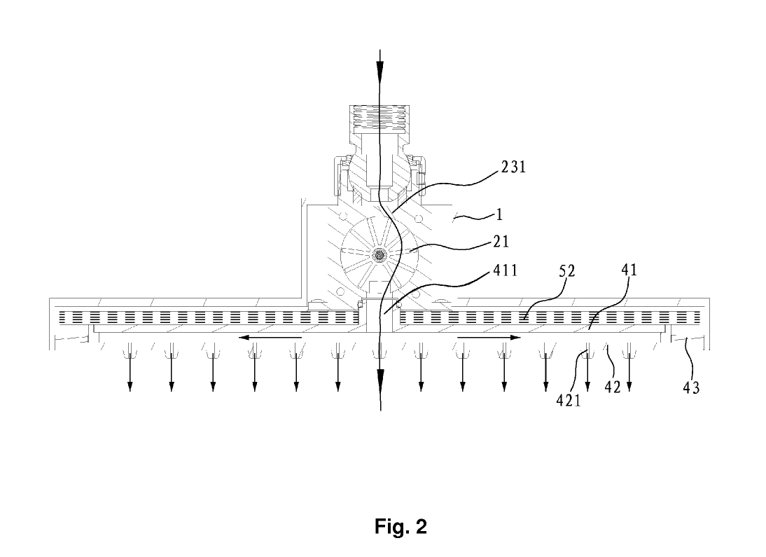

As showed in FIG. 1 and FIG. 2, the illuminable shower head of the present invention comprises a main body 1, a hydroelectric device 2, a circuit board 3, a water outlet device 4 and an illuminant 5.

The hydroelectric device 2 is disposed upon the main body 1, the water outlet device 4 is disposed below the hydroelectric device 2, a space is formed between the peripheries of the water outlet 4 and the main body 1, the LED lights 51 in the illuminant 5 are disposed in said space, further the circuit board 3 is disposed in a space upon the main body 1, the illuminant comprises a plurality of LED lights 51 and a backlight 52, said LED lights 51 are disposed on the side surface of the periphery of the backlight 52 and illuminate toward the backlight 52, said LED lights 51 are arranged on the periphery of the main body 1, the size of the backlight 52 matches the size of the water output panel 41 in the water outlet device 4, further the backlight 52 is disposed in a space upon the water outlet device 4, a through hole 521 is disposed on the middle of the backlight 52 communicated with the water inlet of the water outlet device 4; the hydroelectric device 2, the circuit board 3 and the illuminant 5 are electrically connected with conducting wires.

The hydroelectric device 2 is disposed in the main body 1, as showed in FIG. 1 and FIG. 2; the hydroelectric device 2 comprises an impeller 21, a generator 22, a generator stand 23 and an impeller mask 24; the generator stand 23 is divided into a left chamber and a right chamber, an shaft hole is between the left and right chambers; the generator 22 is installed in the left chamber of the generator stand 23 and forms an airtight space, the input shaft of which extends into the right chamber from the shaft hole; the impeller 21 is installed in the right chamber and connected with the input shaft of the generator 22, the impeller mask 24 is installed outside; the upper portion of the generator stand 23 has an inclined water inlet 231 which is communicated with the right chamber of the generator stand 23; the impeller 21 is vertically disposed below the water inlet of the hollow main body 1 of the shower head, so the water will firstly flow into the hollow main body 1 and pass through the inclined water inlet 231, then directly strikes the impeller 21 and drives the impeller to rotate, the rotation of the impeller 21 will drive the generator generate electricity, therefore the energy utilization ratio is improved.

The water outlet device 4 comprises a transparent face cover 42 with pluralities of water nozzles 421 and a transparent upper cover 41 for face cover, a water inlet 411 is disposed on the middle of the upper cover 41 and hermetically connected with the water outlet of the hydroelectric device 2 after passing through the through hole 521 of the backlight 52, and the face cover 42 buckles and seals the lower end of the main body 1 and forms a water inflow chamber between said face cover 42. In order to prevent the LED lights 51 from exposing through the transparent face cover 42, a shading ornamental ring 43 is disposed on the periphery of the face cover 42 corresponding to the position of the LED lights 51.

When the user takes the bath, firstly the water flows into the main body 1, then passes through the inclined water inlet 321 and strikes the impeller 21, so the impeller 21 will drive the generator 22 generate electricity, the generated electricity is led out by a connecting wire, the connecting wire is connected to the circuit of the circuit board 3, thus the electric current is generated and supplied to the LED lights 51, after that the LED lights will emit light, and the emitted light will illuminate toward the backlight 52, so the whole backlight will be luminous, the light will pass through the transparent upper cover 41 of the water outlet device 4 and the transparent face cover 42, so the whole water output panel of the shower head will be luminous, meanwhile, the water will spray from the water nozzle 421 of the face cover 42 after entering the water inflow chamber through the water inlet 411 of the water outlet device 4, thus the function of shower is realized.

### INDUSTRIAL APPLICABILITY

The technical solution of the present invention applies transparent material for making the water outlet device of the shower head, which further applies a backlight 52 whose size is adapted with the water output panel, so the light emitted from the LED lights 51 can be conducted and unified by the backlight 52 and then illuminates the whole water output panel of the shower head, so the whole water output panel of the shower head will be luminous; moreover, the illuminable water output panel will have the function of illumination.

1. Illuminable shower head, comprising a main body, a hydroelectric device arranged in the main body, a circuit board, an illuminant and a water outlet device arranged in front of the main body; the hydroelectric device is electrically connected with the circuit board and the illuminant; wherein said water outlet device is made of transparent material, said illuminant comprises a backlight and a plurality of LED lights, said backlight is disposed upon said water outlet device, said LED lights are disposed on the side surface of the periphery of the backlight and illuminate toward the backlight.

2. The illuminable shower head according to claim 1, wherein said hydroelectric device comprises an impeller and a generator driven by said impeller.

3. The illuminable shower head according to claim 2, wherein said impeller is vertically disposed below a water inlet of the main body.

4. The illuminable shower head according to claim 2, wherein said hydroelectric device further comprises a generator stand, said impeller and said generator are disposed on the generator stand, an inclined water inlet is arranged on the generator stand, the water directly strikes the impeller after flowing into the hollow main body and then passing through the inclined water inlet, then the impeller drives the generator generate electricity.

5. The illuminable shower head according to claim 1, wherein the hydroelectric device is disposed upon the main body, the water outlet device is disposed below the hydroelectric device, a space is formed between the peripheries of the water outlet device and the main body, the LED lights in the illuminant are disposed in said space, further the circuit board is disposed in a space upon the main body.

6. The illuminable shower head according to claim 1, wherein said water outlet device comprises a transparent face cover with pluralities of water nozzles and a transparent upper cover for said face cover, a water inlet is disposed on the middle of the upper cover and hermetically connected with the hydroelectric device after passing through the backlight, the face cover buckles and seals the lower end of the main body and a water inflow chamber is formed between said face cover and the upper cover.

7. The illuminable shower head according to claim 6, wherein a shading ornamental ring is disposed on the periphery of the face cover and corresponds to the LED lights.

8. The illuminable shower head according to claim 1, wherein the size of the backlight matches the size of the water outlet panel in the water outlet device, further the backlight is disposed in a space upon the water outlet device.

9. The illuminable shower head according to claim 8, wherein a through hole is disposed on the middle of the backlight communicated with the water inlet of the water outlet device.

10. The illuminable shower head according to claim 3, wherein said hydroelectric device further comprises a generator stand, said impeller and said generator are disposed on the generator stand, an inclined water inlet is arranged on the generator stand, the water directly strikes the impeller after flowing into the hollow main body and then passing through the inclined water inlet, then the impeller drives the generator generate electricity.

11. The illuminable shower head according to claim 6, wherein the size of the backlight matches the size of the water outlet panel in the water outlet device, further the backlight is disposed in a space upon the water outlet device.

13. The illuminable shower head according to claim 11, wherein a through hole is disposed on the middle of the backlight communicated with the water inlet of the water outlet device.
